(19) United States
(12) Patent Application Publication
(10) Pub. No.: US 2016/0189339 A1
(43) Pub. Date: Jun. 30, 2016

(54) ADAPTIVE 3D REGISTRATION

(71) Applicant: MANTISVISION LTD., Petah Tikva (IL)

(72) Inventors: Vadim Kosoy, Petach Tikva (IL); Dani Daniel, Haifa (IL)

(21) Appl. No.: 14/786,975

(22) PCT Filed: Apr. 30, 2014
(86) PCT No.: PCT/IL14/50389

§ 371 Date: Oct. 25, 2015

Related U.S. Application Data
(60) Provisional application No. 61/817,481, filed on Apr. 30, 2013.

(51) Int. Cl. G06T 3/00; G06T 7/00; G06T 17/00

(52) U.S. Cl. CPC G06T 3/0068; G06T 17/00; G06T 7/0024; G06T 2207/10028

(57) ABSTRACT

An adaptive error measure, weights and sampling criterion for 3D registration algorithms. Adjusting a sampling criterion for each entity of the 3D model by a factor controlled by a value associated with the expected error for the particular entity, derived from parameters such as accuracy and local 3D model density. Similar adjusted error measure that evaluates the quality of the 3D registration result at different regions of the 3D models, and an adjusted weighting scheme, that assign weight for each entity of the 3D model, are also discussed. In an iterative 3D registration algorithm, adjusted outlier detection criterion after each iteration according to the convergence rate of the algorithm is presented, therefore allowing iterative 3D registration algorithms to escape areas of slow convergence rate and local minima.

### TECHNOLOGICAL FIELD

The invention relates to 3D processing and to 3D registration.

### BACKGROUND

As is known by those versed in the art, 3D registration involves an attempt to align two or more 3D models, by finding or applying spatial transformations over the 3D models. 3D registration is useful in many imaging, graphical, image processing, computer vision, medical imaging, robotics, and pattern matching applications.

Examples of scenarios were 3D registration involves significant challenges include: a moving 3D camera, or multiple 3D cameras with different positions and directions and generating a plurality of 3D models of a static scene from different viewpoints. In these examples, the 3D registration process may involve recovering the relative positions and directions of the different viewpoints. Recovering the relative positions and directions of the different viewpoints can further enable merging of the plurality of 3D models into a single high quality 3D model of the scene. Alternatively, the recovered positions and directions can be used in a calibration process of a multiple 3D camera system, or to reconstruct the trajectory of a single moving camera.

Another scenario were 3D registration can present some challenges is where a static 3D camera is used to generate a series of 3D models of a moving object or scene. Here, the 3D registration process recovers the relative positions and orientations of the object or scene in each 3D model. Recovering the relative positions and orientations of the object or scene in each 3D model can further enables merging of the plurality of 3D models into a single high quality 3D model of the object or scene. Alternatively, the trajectory of the moving object or scene can be reconstructed.

A moving 3D camera, or multiple moving 3D cameras, capturing 3D images of a scene that may include several moving objects. As an example, consider one or more 3D cameras attached to a vehicle, where the vehicle is moving, the relative positions and orientations of the 3D cameras to the vehicle are changing, and objects in the scene are moving. In the above scenario, the 3D registration results can be used to assemble a map or a model of the environment, for example as input to motion segmentation algorithms, and so forth.

When the 3D registration process involves a pair of 3D models, the goal of the 3D registration process is to find a spatial transformation between the two models. This can include rigid and non-rigid transformations. The two 3D models may include coinciding parts that correspond to the same objects in the real world, and parts that do not coincide, corresponding to objects (or parts of objects) in the real world that are modeled in only one of the 3D models. Removing the non-coinciding parts speeds up the convergence of the 3D registration process, and can improve the 3D registration result. This same principal extends naturally to the case of three or more 3D models.

In addition, the 3D registration may be instable due to the geometry of the 3D models that allows two 3D models to “slide” against each other in regions which do not contain enough information to fully constrain the registration, for example, due to uniformity in the appearance of a surface in a certain direction. In such case, selecting, or increasing the weights of, the parts of the 3D models that do constrain the registration in the unconstrained direction, allows these parts to control the convergence of 3D registration algorithm, may also speed up the convergence of the 3D registration algorithm, and may improve the 3D registration result.

### SUMMARY

According to an aspect of the presently disclosed subject matter there is provided a method, a computer implementing a method that include: using an adaptive sampling criterion for a 3D registration algorithm. The proposed method is capable of adjusting the sampling criterion at each step of an iterative 3D registration algorithm (or at least at various steps of an iterative 3D registration algorithm) according to the convergence rate of the algorithm. According to examples of the presently disclosed subject matter, the adaptive sampling criterion can be adjusted so as to allow an iterative 3D registration algorithm that is used in a 3D registration process to escape areas of slow convergence rate (such as around inflection points) and local minima. In addition, the iterative 3D registration algorithm enables setting an expected convergence time, and the sampling criterion can be responsive to the defined convergence time for adjusting the subsequent steps of the 3D registration algorithm accordingly. By way of example, the adjustment of the sampling criterion can be controlled manually, by or a user, and/or in another example, the adjustment of the sampling criterion can be controlled by a computerized process, such as a service utilizing the 3D registration algorithm.

In addition, the sampling criterion for each entity of the 3D model can be adjusted by a controlling factor that is controlled by a controlling value associated with the expected error for the particular entity. By way of example, the sampling criterion can be associated with a control value that is derived from different parameters, including geometrical parameters that relates to the entity, capturing parameters that relates to the entity, and so forth, for example, accuracy and local 3D model density.

According to a further aspect of the presently disclosed subject matter, there is provided a method, a computer implementing a method that includes: an adaptive error measure that can be used to evaluate the quality of a 3D registration result at different regions of 3D models. According to a further aspect of the presently disclosed subject matter, there is provided a method, a computer implementing a method that includes: assigning an adaptive weight function to different entities of the 3D model.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a simplified block diagram of an example for one possible implementation of a mobile communication device with 3D capturing capabilities.

FIG. 2 is a simplified block diagram of an example for one possible implementation of a system that includes a mobile communication device with 3D capturing capabilities and a cloud platform.

FIG. 3 is an illustration of a possible scenario in which a plurality of 3D models is generated by a single 3D camera.

FIG. 4 is an illustration of a possible scenario in which a plurality of 3D models is generated by a plurality of 3D cameras.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION

In the following detailed description, numerous specific details are set forth in order to provide a thorough understanding of the invention. However, it will be understood by those with ordinary skill in the art that the present invention may be practiced without these specific details. In other instances, well-known methods, procedures, and components have not been described in detail so as not to obscure the present invention.

Unless specifically stated otherwise, as apparent from the following discussions, it is appreciated that throughout the specification discussions utilizing terms such as “processing”, “calculating”, “computing”, “determining”, “generating”, “setting”, “configuring”, “selecting”, “defining”, “applying”, “obtaining”, or the like, include action and/or processes of a computer that manipulate and/or transform data into other data, said data represented as physical quantities, e.g. such as electronic quantities, and/or said data representing the physical objects. The terms “computer”, “processor”, “controller”, “processing unit”, and “computing unit” should be expansively construed to cover any kind of electronic device, component or unit with data processing capabilities, including, by way of non-limiting example, a personal computer, a tablet, a smartphone, a server, a computing system, a communication device, a processor (for example, digital signal processor (DSP), and possibly with embedded memory), a microcontroller, a field programmable gate array (FPGA), an application specific integrated circuit (ASIC), a graphics processing unit (GPU), and so on), a core within a processor, any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more stages illustrated in the figures may be executed in a different order and/or one or more groups of stages may be executed simultaneously and vice versa. The figures illustrate a general schematic of the system architecture in accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

The term “3D model” is recognized by those with ordinary skill in the art and refers to any kind of representation of any 3D surface, 3D object, 3D scene, 3D prototype, 3D shape, 3D design and so forth, either static or moving. A 3D model can be represented in a computer in different ways. Some example includes the popular range image, where one associate a depth for pixels of a regular 2D image. Another simple example is the point cloud, where the model consists of a set of 3D points. A different example is using polygons, where the model consists of a set of polygons. Special types of polygon based models include: (i) polygon soup, where the polygons are unsorted; (ii) mesh, where the polygons are connected to create a continuous surface; (iii) subdivision surface, where a sequence of meshes is used to approximate a smooth surface; (iv) parametric surface, where a set of formulas are used to describe a surface; (v) implicit surface, where one or more equations are used to describe a surface; (vi) and so forth. Another example is to represent a 3D model as a skeleton model, where a graph of curves with radii is used. Additional examples include a mixture of any of the above methods. There are also many variants on the above methods, as well as a variety of other methods. It is important to note that one may convert one kind of representation to another, at the risk of losing some information, or by making some assumptions to complete missing information.

The term “3D registration process” is recognized by those with ordinary skill in the art and refers to the process of finding one or more spatial transformations that aligns two or more 3D models, and/or for transforming two or more 3D models into a single coordinate system.

The term “3D registration algorithm” is recognized by those with ordinary skill in the art and refers to any process, algorithm, method, procedure, and/or technique, for solving and/or approximating one or more solutions to the 3D registration process. Some examples for 3D registration algorithms include the Iterative Closest Point algorithm, the Robust Point Matching algorithm, the Kernel Correlation algorithm, the Coherent Point Drift algorithm, RANSAC based algorithms, any graph and/or hypergraph matching algorithm, any one of the many variants of these algorithms, and so forth.

The term “iterative 3D registration algorithm” is recognized by those with ordinary skill in the art and refers to a 3D registration algorithm that repeatedly adjusts an estimation of the 3D registration until convergence, possibly starting from an initial guess for the 3D registration.

The term “3D registration result” is recognized by those with ordinary skill in the art and refers to the product of a 3D registration algorithm. This may be in the form of: spatial transformations between pairs of 3D models; spatial transformations for transforming all the 3D models into a single coordinate system; representation of all the 3D models in a single coordinate system; and so forth.

The term “estimated 3D registration” is recognized by those with ordinary skill in the art and refers to any estimation of 3D registration result. In one example, the estimation may be a random guess for the 3D registration result. In an iterative 3D registration algorithm, each iteration updates an estimation of 3D registration result to obtain a new estimation. A 3D registration result by itself can also be an estimated 3D registration. And so forth.

The term “3D camera” is recognized by those with ordinary skill in the art and refers to any type of device, including a camera and/or a sensor, which is capable of capturing 3D images, 3D videos, and/or 3D models. Examples include: stereoscopic cameras, time-of-flight cameras, obstructed light sensors, structured light sensors, and so forth.

It should be noted that some examples of the presently disclosed subject matter are not limited in application to the details of construction and the arrangement of the components set forth in the following description or illustrated in the drawings. The invention can be capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different figures may use different scales and different scales can be used even within the same drawing, for example different scales for different views of the same object or different scales for the two adjacent objects.

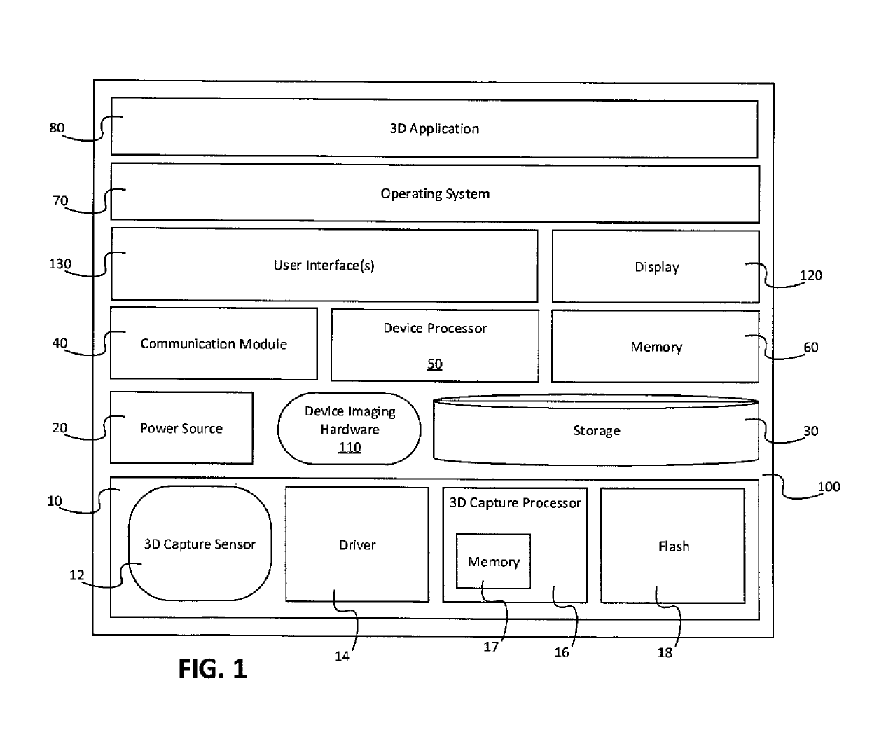

FIG. 1 is a simplified block diagram of an example for one possible implementation of a mobile communication device with 3D capturing capabilities. The mobile communication device 100 can includes a 3D camera 10 that is capable of providing 3D depth or range data. In the example of FIG. 1 there is shown a configuration of an active stereo 3D camera, but in further examples of the presently disclosed subject matter other known 3D cameras can be used. Those versed in the art can readily apply the teachings provided in the examples of the presently disclosed subject matter to other 3D camera configurations and to other 3D capture technologies.

By way of example, the 3D camera 10 can include: a 3D capture sensor 12, a driver 14, a 3D capture processor 16 and a flash module 18. In this example, the flash module 18 is configured to project a structured light pattern and the 3D capture sensor 12 is configured to capture an image which corresponds to the reflected pattern, as reflected from the environment onto which the pattern was projected. U.S. Pat. No. 8,090,194 to Gordon et. al. describes an example structured light pattern that can be used in a flash component of a 3D camera, as well as other aspects of active stereo 3D capture technology and is hereby incorporated into the present application in its entirety. International Application Publication No. WO2013/144952 describes an example of a possible flash design and is hereby incorporated by reference in its entirety.

By way of example, the flash module 18 can include an IR light source, such that it is capable of projecting IR radiation or light, and the 3D capture sensor 12 can be and IR sensor, that is sensitive to radiation in the IR band, and such that it is capable of capturing the IR radiation that is returned from the scene. The flash module 18 and the 3D capture sensor 12 are calibrated. According to examples of the presently disclosed subject matter, the driver 14, the 3D capture processor 16 or any other suitable component of the mobile communication device 100 can be configured to implement auto-calibration for maintaining the calibration among the flash module 18 and the 3D capture sensor 12.

The 3D capture processor 16 can be configured to perform various processing functions, and to run computer program code which is related to the operation of one or more components of the 3D camera. The 3D capture processor 16 can include memory 17 which is capable of storing the computer program instructions that are executed or which are to be executed by the processor 16.

The driver 14 can be configured to implement a computer program which operates or controls certain functions, features or operations that the components of the 3D camera 10 are capable of carrying out.

According to examples of the presently disclosed subject matter, the mobile communication device 100 can also include hardware components in addition to the 3D camera 10, including for example, a power source 20, storage 30, a communication module 40, a device processor 50 and memory 60, device imaging hardware 110, a display unit 120, and other user interfaces 130. It should be noted that in some examples of the presently disclosed subject matter, one or more components of the mobile communication device 100 can be implemented as distributed components. In such examples, a certain component can include two or more units distributed across two or more interconnected nodes. Further by way of example, a computer program, possibly executed by the device processor 50, can be capable of controlling the distributed component and can be capable of operating the resources on each of the two or more interconnected nodes.

It is known to use various types of power sources in a mobile communication device. The power source 20 can include one or more power source units, such as a battery, a short-term high current source (such as a capacitor), a trickle-charger, etc.

The device processor 50 can include one or more processing modules which are capable of processing software programs. The processing module can each have one or more processors. In this description, the device processor 50 may include different types of processors which are implemented in the mobile communication device 100, such as a main processor, an application processor, etc. The device processor 50 or any of the processors which are generally referred to herein as being included in the device processor can have one or more cores, internal memory or a cache unit.

The storage unit 30 can be configured to store computer program code that is necessary for carrying out the operations or functions of the mobile communication device 100 and any of its components. The storage unit 30 can also be configured to store one or more applications, including 3D applications 80, which can be executed on the mobile communication device 100. In a distributed configuration one or more 3D applications 80 can be stored on a remote computerized device, and can be consumed by the mobile communication device 100 as a service. In addition or as an alternative to application program code, the storage unit 30 can be configured to store data, including for example 3D data that is provided by the 3D camera 10.

The communication module 40 can be configured to enable data communication to and from the mobile communication device. By way of example, examples of communication protocols which can be supported by the communication module 40 include, but are not limited to cellular communication (3G, 4G, etc.), wired communication protocols (such as Local Area Networking (LAN)), and wireless communication protocols, such as Wi-Fi, wireless personal area networking (PAN) such as Bluetooth, etc.

It should be noted that that according to some examples of the presently disclosed subject matter, some of the components of the 3D camera 10 can be implemented on the mobile communication hardware resources. For example, instead of having a dedicated 3D capture processor 16, the device processor 50 can be used. Still further by way of example, the mobile communication device 100 can include more than one processor and more than one type of processor, e.g., one or more digital signal processors (DSP), one or more graphical processing units (GPU), etc., and the 3D camera can be configured to use a specific one (or a specific set or type) processor(s) from the plurality of device 100 processors.

The mobile communication device 100 can be configured to run an operating system 70. Examples of mobile device operating systems include but are not limited to: such as Windows Mobile™ by Microsoft Corporation of Redmond, Wash., and the Android operating system developed by Google Inc. of Mountain View, Calif.

The 3D application 80 can be any application which uses 3D data. Examples of 3D applications include a virtual tape measure, 3D video, 3D snapshot, 3D modeling, etc. It would be appreciated that different 3D applications can have different requirements and features. A 3D application 80 may be assigned to or can be associated with a 3D application group. In some examples, the device 100 can be capable of running a plurality of 3D applications 80 in parallel.

Imaging hardware 110 can include any imaging sensor, in a particular example, an imaging sensor that is capable of capturing visible light images can be used. According to examples of the presently disclosed subject matter, the imaging hardware 110 can include a sensor, typically a sensor that is sensitive at least to visible light, and possibly also a light source (such as one or more LEDs) for enabling image capture in low visible light conditions. According to examples of the presently disclosed subject matter, the device imaging hardware 110 or some components thereof can be calibrated to the 3D camera 10, and in particular to the 3D capture sensor 12 and to the flash 18. It would be appreciated that such a calibration can enable texturing of the 3D image and various other co-processing operations as will be known to those versed in the art.

In yet another example, the imaging hardware 110 can include a RGB-IR sensor that is used for capturing visible light images and for capturing IR images. Still further by way of example, the RGB-IR sensor can serve as the 3D capture sensor 12 and as the visible light camera. In this configuration, the driver 14 and the flash 18 of the 3D camera, and possibly other components of the device 100, are configured to operate in cooperation with the imaging hardware 110, and in the example given above, with the RGB-IR sensor, to provide the 3D depth or range data.

The display unit 120 can be configured to provide images and graphical data, including a visual rendering of 3D data that was captured by the 3D camera 10, possibly after being processed using the 3D application 80. The user interfaces 130 can include various components which enable the user to interact with the mobile communication device 100, such as speakers, buttons, microphones, etc. The display unit 120 can be a touch sensitive display which also serves as a user interface.

According to some examples of the presently disclosed subject matter, any processing unit, including the 3D capture processor 16 or the device processor 50 and/or any sub-components or CPU cores, etc. of the 3D capture processor 16 and/or the device processor 50, can be configured to read 3D images and/or frames of 3D video clips stored in storage unit 30, and/or to receive 3D images and/or frames of 3D video clips from an external source, for example through communication module 40; produce 3D models out of said 3D images and/or frames. By way of example, the produced 3D models can be stored in storage unit 30, and/or sent to an external destination through communication module 40. According to further examples of the presently disclosed subject matter, any such processing unit can be configured to execute 3D registration on a plurality of 3D models.

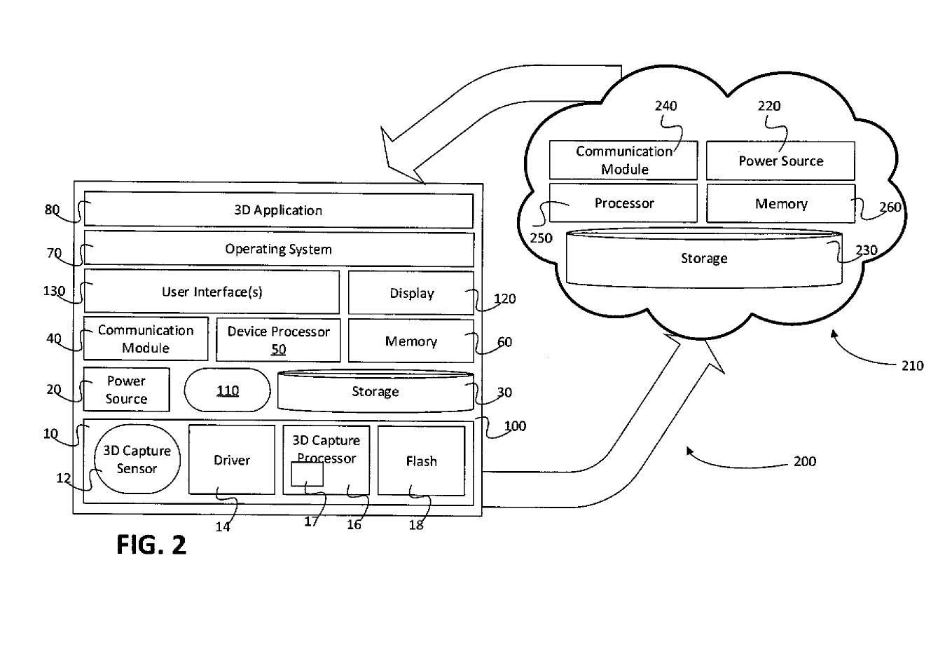

FIG. 2 is a simplified block diagram of an example for one possible implementation of a system 200, that includes a mobile communication device with 3D capturing capabilities 100, and a could platform 210 which includes resources that allows the execution of 3D registration.

According to examples of the presently disclosed subject matter, the cloud platform 210 can include hardware components, including for example, one or more power sources 220, one or more storage units 230, one or more communication modules 240, one or more processors 250, optionally one or more memory units 260, and so forth.

The storage unit 230 can be configured to store computer program code that is necessary for carrying out the operations or functions of the cloud platform 210 and any of its components. The storage unit 230 can also be configured to store one or more applications, including 3D applications, which can be executed on the cloud platform 210. In addition or as an alternative to application program code, the storage unit 230 can be configured to store data, including for example 3D data.

The communication module 240 can be configured to enable data communication to and from the cloud platform. By way of example, examples of communication protocols which can be supported by the communication module 240 include, but are not limited to cellular communication (3G, 4G, etc.), wired communication protocols (such as Local Area Networking (LAN)), and wireless communication protocols, such as Wi-Fi, wireless personal area networking (PAN) such as Bluetooth, etc.

The one or more processors 250 can include one or more processing modules which are capable of processing software programs. The processing module can each have one or more processing units. In this description, the device processor 250 may include different types of processors which are implemented in the cloud platform 210, such as general purpose processing units, graphic processing units, physics processing units, etc. The device processor 250 or any of the processors which are generally referred to herein can have one or more cores, internal memory or a cache unit.

According to examples of the presently disclosed subject matter, the one or more memory units 260 may include several memory units. Each unit may be accessible by all of the one or more processors 250, or only by a subset of the one or more processors 250.

According to some examples of the presently disclosed subject matter, any processing unit, including the one or more processors 250 and/or any sub-components or CPU cores, etc. of the one or more processors 250, can be configured to read 3D images and/or frames of 3D video clips stored in storage unit 230, and/or to receive 3D images and/or frames of 3D video clips from an external source, for example through communication module 240, where, by a way of example, the communication module may be communicating with the mobile communication device 100, with another cloud platform, and so forth. By a way of example, the processing unit can be further configured to produce 3D models out of said 3D images and/or frames. Further by a way of example, the produced 3D models can be stored in storage unit 230, and/or sent to an external destination through communication module 240. According to further examples of the presently disclosed subject matter, any such processing unit can be configured to execute 3D registration on a plurality of 3D models.

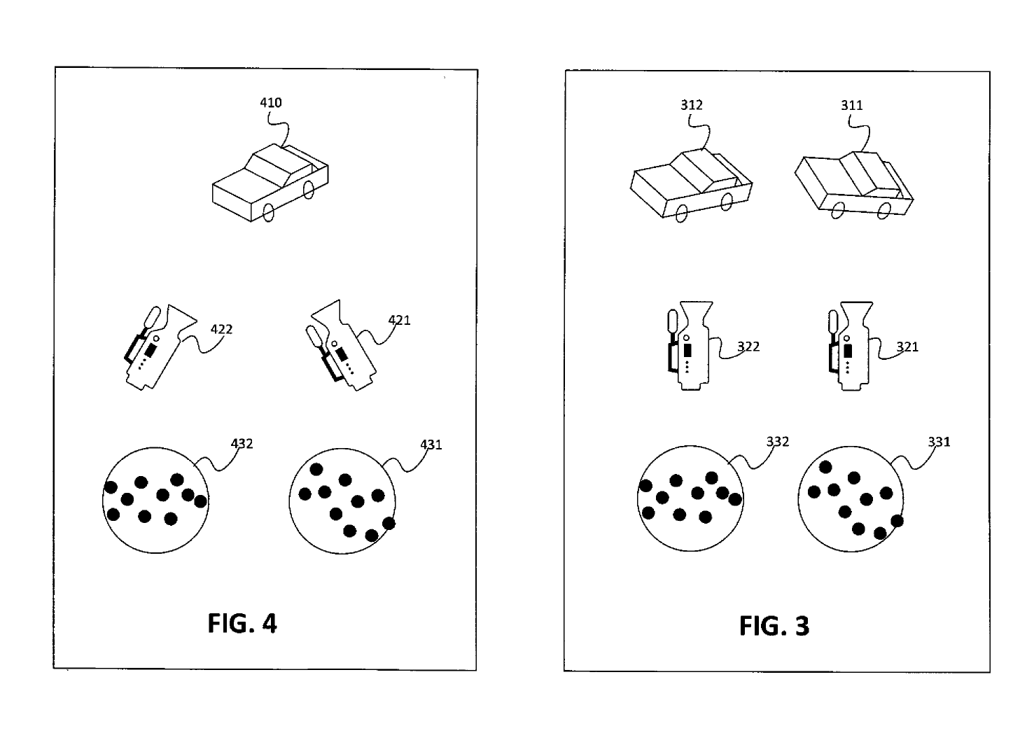

FIG. 3 is an illustration of a possible scenario in which a plurality of 3D models is generated by a single 3D camera. A moving object is captured at two sequential points in time. We will denote the earliest point in time as T1, and the later point in time as T2. 311 is the object at T1, and 312 is the object at T2. 321 is the single 3D camera at time T1, which generates a 3D model 331 of the object at time T1 (311). Similarly, at time T2 the single 3D camera (322) generates the 3D model 332 of the object (312).

According to further examples of the presently disclosed subject matter, 3D registration is used to align 3D model 331 with 3D model 332. Further by a way of example, the 3D registration result can be used to reconstruct the trajectory of the moving object 311 and 312.

FIG. 4 is an illustration of a possible scenario in which a plurality of 3D models is generated by a plurality of 3D cameras. A single object 410 is captured by two 3D cameras: 3D camera 421 generates the 3D model 431, and 3D camera 422 generates the 3D model 432.

According to further examples of the presently disclosed subject matter, 3D registration is used to align 3D model 431 with 3D model 432. Further by a way of example, the 3D registration result can be used to reconstruct a single combined 3D model of the object 410 from the two 3D models 431 and 432.

It is hereby assumed that a 3D registration algorithm treats at least one of the 3D models as a group of separated entities, possibly while holding additional information about the relations among the entities. For example: when representing the 3D model as a point cloud, an entity can be a point; when representing the 3D model as a group of polygons, the entity may be a polygon; when representing the 3D model as a skeleton model, each curve and/or a radii may be an entity; when representing the 3D model as a graph or a hypergraph, each node and/or vertex may be an entity; and so forth. In such case, at each point in time an error for each entity can be estimated.

There are many different possible error measures that can be used in accordance with examples of the presently disclosed subject matter. One straightforward possibility is to take any distance measure and treat it as an error measure. For example, when dealing with two point cloud 3D models, the distance between the point and the point closest to it in the second point cloud can be obtained and used as an error measure. Note that the distance can be measured using any distance measure, including Euclidean distance, Manhattan distance, and so forth. As another example, when dealing with one point cloud 3D model and one polygon based 3D model, the distance between the point and the polygon closest to it can be used. In a different example, when dealing with two polygon based 3D models, any non-negative similarity measure can be used between polygons to convert it to distance, for example if the similarity of two polygons is s, a possible distance is exp(-s), and again the distance from a polygon to the nearest polygon in the second 3D model can be obtained and used as error measure.

According to examples of the presently disclosed subject matter, the error measures can be utilized for many different usages. For example, the error measure can be used in evaluating the different entities to identify outliers. These outliers may be removed from the calculation before applying a 3D registration algorithm. In an iterative 3D registration algorithm, after each iteration the error measure can be recalculated and more outliers can be identified. Further by way of example, the identified outlier can possibly be removed from the calculation before further iterations take place. As another example, the error measure can be used to estimate the convergence rate and/or as a stopping condition for an iterative 3D registration algorithm.

Still further by way of example, an outlier detection criterion can be thought as a condition on a function of the entities error. For example, assume n entities with errors e₁, . . . , eₙ. A possible outliers detection criterion can be based on the following formula (formula (1)),

eᵢ>f(e₁, . . . , eₙ), formula (1)

where f(e₁, . . . , eₙ) is a function of e₁, . . . , eₙ. Formula (1) uses the function, f(e₁, . . . , eₙ), as a threshold, and treat any entity corresponding to an error greater than the threshold as an outlier. Some possible examples for the function f(e₁, . . . , eₙ) includes: the mean function, the median function, a function of the mean and/or median together with the standard deviation and/or the variance, any other statistical function of the errors, e₁, . . . , eₙ, and so on.

According to examples of the presently disclosed subject matter, another usage of the error measure can be in setting weights for the different entities. For example, giving different weights to different entities can guide the algorithm towards a solution that favors lower error on these entities. As another example, assigning different weights to different entities can control the effect of each entity on an iterative 3D registration algorithm stopping criterion. According to further examples of the presently disclosed subject matter, the weight of an entity can be set as a function of the entities error. For example, given n entities with errors e₁, . . . , eₙ, the weight wᵢ of the i-th entity can be set according to the following formula (formula (2)),

wᵢ=z(eᵢ, e₁, . . . , eₙ), formula (2)

where z(eᵢ, e₁, . . . , eₙ) is a function of, e₁, . . . , eₙ, and the weighting policy is to assign to the i-th entity the weight z(eᵢ, e₁, . . . , eₙ). As a possible example for the function z(eᵢ, e₁, . . . , eₙ) consider the following formula (formula (3)),

$${w}_{i} = z ( {e}_{i} , {e}_{1} , … , {e}_{n} ) = \frac{exp ( - \frac{{e}_{i }}{f ( {e}_{1} , … , {e}_{n} )} )}{{\sum }_{j = 1}^{n} exp ( - \frac{{e}_{j}}{f ( {e}_{1} , … , {e}_{n} )} )} . \qquad formula ( 3 )$$

As another example for the function z(eᵢ, e₁, . . . , eₙ) consider the following formula (formula (4)),

$${w}_{i} = z ( {e}_{i} , {e}_{1} , … , {e}_{n} ) = \frac{{( \frac{{e}_{i }}{f ( {e}_{1} , … , {e}_{n} )} )}^{- 1}}{{\sum }_{j = 1}^{n} {( \frac{{e}_{j}}{f ( {e}_{1} , … , {e}_{n} )} )}^{- 1 }} . \qquad formula ( 4 )$$

According to further examples of the presently disclosed subject matter, in an iterative 3D registration algorithm, it is also possible to update an entity weight instead of completely recalculating it, or in other words, to take into account previous values of the entity's weight in the calculation of the new weight for the entity. For example, let wᵢ^{t} be the weight of the i-th entity at iteration t, the weight can be updated and a weight wᵢ^{t+1} for can be obtained for the entity in iteration t+1 according to the following formula (formula (5)),

wᵢ^{t+1}=y(wᵢ^{t}, eᵢ, e₁, . . . , eₙ), formula (5)

where y(wᵢ^{t}, eᵢ, e₁, . . . , eₙ) is a function of the previous weight for the i-th entity, wᵢ^{t}, and the errors, e₁, . . . , eₙ, and the weighting policy is to assign to the i-th entity the weight y(wᵢ^{t}, eᵢ, e₁, . . . , eₙ). As a possible example for the function y(wᵢ^{t}, eᵢ, e₁, . . . , eₙ) consider the following formula (formula (6)),

$${w}_{i}^{t + 1} = y ( {w}_{i}^{t} , {e}_{i} , {e}_{1} , … , {e}_{n} ) = {w}_{i}^{t} \cdot exp ( - \frac{{e}_{i }}{f ( {e}_{1} , … , {e}_{n} )} ) . \qquad formula ( 6 )$$

As another example for the function y(wᵢ^{t}, eᵢ, e₁, . . . , eₙ) consider the following formula (formula (7)),

$${w}_{i}^{t + 1} = y ( {w}_{i}^{t} , {e}_{i} , {e}_{1} , … , {e}_{n} ) = {w}_{i}^{t} \cdot {( \frac{{e}_{i }}{f ( {e}_{1} , … , {e}_{n} )} )}^{- 1} . \qquad formula ( 7 )$$

According to further examples of the presently disclosed subject matter, another usage of the measure can be in the evaluation of different entities at the end of a 3D registration algorithm, as a way to evaluate the quality of the 3D registration result for each entity, or the overall 3D registration result, for example by using the sum of all the entities error, by using the weighted sum, and so forth. For example, given n entities with errors e₁, . . . , eₙ, a possible measure of quality associated with the i-th entity, qᵢ, can be calculated according to the following formula (formula (8)),

qᵢ=v(eᵢ, e₁, . . . , eₙ), formula (8)

where v(eᵢ, e₁, . . . , eₙ) is a function of, e₁, . . . , eₙ. As a possible example for the function v(eᵢ, e₁, . . . , eₙ) consider the following formula (formula (9)),

$${q}_{i} = v ( {e}_{i} , {e}_{1} , … , {e}_{n} ) = exp ( - \frac{{e}_{i }}{f ( {e}_{1} , … , {e}_{n} )} ) , \qquad formula ( 9 )$$

where a higher value corresponds to a higher quality and vice versa. Another possible example is as follows (formula (10)),

$${q}_{i} = v ( {e}_{i} , {e}_{1} , … , {e}_{n} ) = {( \frac{{e}_{i }}{f ( {e}_{1} , … , {e}_{n} )} )}^{- 1} , \qquad formula ( 10 )$$

It would be noted that the error can depend on the neighborhood of the entity. Assume for example the Euclidean distance to the closest entity in the second entity as an error measure. A misaligned entity in a dense region may have smaller distance than a correctly aligned entity in a sparse region. Examples of the presently disclosed subject matter, include an error adjustment feature, as described below.

According to examples of the presently disclosed subject matter, each entity error can be adjusted based on parameters extracted from a neighborhood of the entity in the 3D model. According to examples of the presently disclosed subject matter, when a 3D registration result or an estimated 3D registration is available, the error adjustment may also be based on parameters extracted from the neighborhood or region of the second 3D model that the entity is nearest to. Further by a way of example, the adjustment can also be based on other parameters related to the entity, such as accuracy estimation provided by the 3D model capturing process for this entity, and so forth.

Let pᵢ be parameters corresponding to the i-th entity, and let e̅ᵢ̅ be the original error associated with the i-th entity. According to examples of the presently disclosed subject matter, e̅ᵢ̅ can be replaced with an adjusted error as defined in the following formula (formula (11)),

eᵢ=g(e̅ᵢ̅,pᵢ), formula (11)

where g is a function that takes the original error and parameters related to the entity, and provides a new error that is adjusted according to these parameters. Using this adjusted error, formula (1) for the outliers detection criterion becomes,

g(e̅ᵢ̅,pᵢ)>f(g(e̅₁̅,p₁), . . . , g(e̅ₙ̅,pₙ)). formula (12)

Similarly, plugging formula (11) into formulas formula (2)-formula (10) produce new formulas for assigning weights and measuring quality. For instance, plugging formula (11) into formula (3) produce the following weight assignment formula (formula (13)),

$${w}_{i} = \frac{exp ( - \frac{g ( \overline{{e}_{i}} , {p}_{i} )}{f ( g ( \overline{{e}_{1}} , {p}_{1} ) , … , g ( \overline{{e}_{n}} , {p}_{n} ) )} )}{{\sum }_{j = 1}^{n} exp ( - \frac{g ( \overline{{e}_{j}} , {p}_{j} )}{f ( g ( \overline{{e}_{1}} , {p}_{1} ) , … , g ( \overline{{e}_{n}} , {p}_{n} ) )} )} , \qquad formula ( 13 )$$

plugging formula (11) into formula (6) produce the following weight update formula (formula (14)),

$${w}_{i}^{t + 1} = {w}_{i}^{t} \cdot exp ( - \frac{g ( \overline{{e}_{i}} , {p}_{i} )}{f ( g ( \overline{{e}_{1}} , {p}_{1} ) , … , g ( \overline{{e}_{n}} , {p}_{n} ) )} ) , \qquad formula ( 14 )$$

plugging formula (11) into formula (9) produce the following quality measure formula (formula (15)),

$${q}_{i} = exp ( - \frac{g ( \overline{{e}_{i}} , {p}_{i} )}{f ( g ( \overline{{e}_{1}} , {p}_{1} ) , … , g ( \overline{{e}_{n}} , {p}_{n} ) )} ) , \qquad formula ( 15 )$$

and so forth.

According to examples of the presently disclosed subject matter, as an example, in case distance is used as an error measure, pᵢ can be set to be the distance to the second nearest entity in the second entity, and use, eᵢ=ġ(e̅ᵢ̅,pᵢ)=e̅ᵢ̅/pᵢ, which produces an adjusted error, 0<eᵢ≦1, that is higher when the difference between the two distances is smaller. As another example, pᵢ can be set to be a positive measure of the density around the matched entities in the two or more 3D models, and use, eᵢ=\ddot{g}(e̅ᵢ̅,pᵢ)=e̅ᵢ̅/pᵢ, or,

$${e}_{i} = {g}^{…} ( \overline{{e}_{i}} , {p}_{i} ) = \sqrt[{p}_{i }]{\overline{{e}_{i}}} ,$$

where both produce an adjusted error eᵢ that is higher when the density is smaller. An additional example includes setting pᵢ to a non-negative estimate of the accuracy of the entity, for example when such estimate is provided by the capturing mechanism. In such case, eᵢ=ĝ(e̅ᵢ̅/pᵢ)=e̅ᵢ̅/pᵢ can be used, which produces an adjusted error, eᵢ, that is lower when the accuracy estimation is higher. Other possibilities include any combination of the above, and so forth.

When dealing with an iterative 3D registration algorithm, the error adjustment process can be repeated after each iteration. In such case, denote the process can take place prior to the first iteration with t=0, and the variables in that process can be denoted by a superscript zero. For example, the notation eᵢ becomes eᵢ⁰, pᵢ becomes pᵢ⁰, e̅ᵢ̅ becomes e̅ᵢ̅⁰̅, wᵢ becomes wᵢ⁰, and so on. Denote the process that takes place after the t-th iteration with a superscript t. For example, the notation eᵢ becomes eᵢ^{t}, pᵢ becomes pᵢ^{t}, e̅ᵢ̅ becomes e̅ᵢ̅^̅{̅t̅}̅, wᵢ becomes wᵢ^{t}, and so on.

According to examples of the presently disclosed subject matter, in the case of iterative 3D registration algorithm, t can be added as an additional parameter to our error adjustment process. Therefore the error adjustment becomes,

eᵢ^{t}=g(e̅ᵢ̅^̅{̅t̅}̅,pᵢ^{t},t), formula (16)

where g is a function that takes the original error and parameters related to the entity, and produce a new error that is adjust according to these parameters. Plugging the adjusted error from formula (16) into the outliers detection criterion of formula (1), the outliers detection criterion becomes,

g(e̅ᵢ̅^̅{̅t̅}̅,pᵢ^{t},t)>f(g(e̅₁̅^̅{̅t̅}̅,p₁^{t},t), . . . , g(e̅ₙ̅^̅{̅t̅}̅,pₙ^{t},t)). formula (17)

Similarly, plugging formula (16) into formulas formula (2)-formula (7) produce new formulas for assigning weights. For instance, plugging formula (16) into formula (3) produce the following weight assignment formula (formula (18)),

$${w}_{i}^{t} = \frac{exp ( - \frac{g ( \overline{{e}_{i}^{t}} , {p}_{i}^{t} , t )}{f ( g ( \overline{{e}_{1}^{t}} , {p}_{1}^{t} , t ) , … , g ( \overline{{e}_{n}^{t}} , {p}_{n}^{t} , t ) )} )}{{\sum }_{j = 1}^{n} exp ( - \frac{g ( \overline{{e}_{j}^{t}} , {p}_{j}^{t} , t )}{f ( g ( \overline{{e}_{1}} , {p}_{1}^{t} , t ) , … , g ( \overline{{e}_{n}} , {p}_{n}^{t} , t ) )} )} , \qquad formula ( 18 )$$

plugging formula (16) into formula (6) produce the following weight update formula (formula (19)),

$${w}_{i}^{t + 1} = {w}_{i}^{t} \cdot exp ( - \frac{g ( \overline{{e}_{i}^{t}} , {p}_{i}^{t} , t )}{f ( g ( \overline{{e}_{1}^{t}} , {p}_{1}^{t} , t ) , … , g ( \overline{{e}_{n}^{t}} , {p}_{n}^{t} , t ) )} ) , \qquad formula ( 19 )$$

and so forth.

According to examples of the presently disclosed subject matter, in the case of iterative 3D registration algorithm, the parameters related to an entity may also be based on information from previous iterations. For example, pᵢ^{t} can be set to be a measure of the change in estimated location after transformation of an entity caused by the last iteration, and, eᵢ^{t}=\check{g}(e̅ᵢ̅^̅{̅t̅}̅,pᵢ^{t},t)=e̅ᵢ̅^̅{̅t̅}̅+pᵢ^{t} can be used, therefore increasing the error of entities with a wide change in estimated location, assuming that a wide change is evidence to uncertainty in the location estimation. As another example, pᵢ^{t} can be set to be the original error in the previous iteration, pᵢ^{t}=e̅ᵢ̅^̅{̅t̅-̅1̅}̅, and use, eᵢ^{t}=\tilde{g}(e̅ᵢ̅^̅{̅t̅}̅,pᵢ^{t},t)=e̅ᵢ̅^̅{̅t̅}̅+pᵢ^{t}/2, therefore balancing the current error estimation with the previous one. Other possibilities include any combination of the above, and so forth.

According to further examples of the presently disclosed subject matter, as example of using the parameter t, consider an adjustment function that is a linear sum of two components, where the coefficients are controlled by t in order to change the weight of the two functions based on the number of iterations,

eᵢ^{t}=a(t)·g′(e̅ᵢ̅^̅{̅t̅}̅,pᵢ^{t},t)+b(t)·g″(e̅ᵢ̅^̅{̅t̅}̅,pᵢ^{t},t). formula (20)

Consider an outliers detection criterion of the form,

eᵢ^{t}>θ, formula (21)

where eᵢ^{t} is an error associated with the i-th entity after the t-th iteration, possibly after adjustment as described above or by any other method, and θ is a threshold calculated in any way and using any set of parameters, possibly as described in formula (17) where, θ=f(g(e̅₁̅^̅{̅t̅}̅,p₁^{t},t), . . . , g(e̅ₙ̅^̅{̅t̅}̅,pₙ^{t},t)). According to examples of the presently disclosed subject matter, in the case of an iterative 3D registration algorithm, any criterion such the one in formula (21) can be adjusted to,

eᵢ^{t}+h(pᵢ^{t},t)>θ. formula (22)

Note that since h(pᵢ^{t},t) is not part of the adjusted error, it does not affect the value of the threshold θ.

According to examples of the presently disclosed subject matter, pᵢ^{t} can, for example, be set to be a measure of the overall change in estimated location after transformation of an entity caused by the last m iteration, where m is a constant number, and use, h(pᵢ^{t},t)=\dot{h}(pᵢ^{t},t)=pᵢ^{t}·k(t), where k(t) can be a monotonically increasing function, k(0)≦k(1)≦k(2)≦ . . . . This assumes that large changes in the estimated location of an entity in the last iterations are evidence that the entity estimated location is far from convergence, and therefore promotes disregarding such entities. Multiplying it with the function k(t) increases the susceptibility of entities with larger changes in their estimated location to the outliers detection criterion as the algorithm progresses, therefore promoting the removal of such points as time passes. As another example, pᵢ^{t} can be set to be the decrease in the original error from the previous iteration, pᵢ^{t}=e̅ᵢ̅^̅{̅t̅-̅1̅}̅−e̅ᵢ̅^̅{̅t̅}̅, and use, h(pᵢ^{t},t)=\ddot{h}(pᵢ^{t},t)=k(t)/pᵢ^{t}, therefore promoting the disregard of entities with smaller decrease in error. Again, multiplying it with the function k(t) increases the susceptibility of entities with larger changes in their estimated location to the outliers detection criterion as the algorithm progresses, therefore promoting the removal of such points as time passes. Other possibilities include any combination of the above, and so forth.

In a further aspect, the above scheme can also be applied to 2D models. Here, the algorithm is a 2D registration algorithm. Assuming that at least one of the 2D model is constructed out of entities, an error is calculated for each entity. The error can then be adjusted, used in the assignment of weights and/or update of weights for the different entities, used in the calculation of quality associated with each entity, and so forth.

In a further aspect, the above scheme can also be applied to a registration of one or more 2D models, and one or more 3D models.

In a further aspect, the adjusted errors can be used in a stopping criterion for an iterative 3D registration algorithm, replacing the original errors with the adjusted errors in the stopping criterion.

1. A method, comprising:
obtaining a plurality of 3D models, wherein the first 3D model is composed of n entities;
obtaining an estimated 3D registration among the plurality of 3D models;
calculating an original error for each of the n entities based on the estimated 3D registration, therefore obtaining n original errors corresponding to the n entities;
calculating a set of parameters for each of the n entities, therefore obtaining n sets of parameters corresponding to the n entities;
calculating an adjusted error for each of the n entities based on the n original errors and the n sets of parameters, therefore obtaining n adjusted errors corresponding to the n entities;
processing information related to the n entities based on the n adjusted errors.

2. The method of claim 1, wherein the plurality of 3D models is exactly two 3D models.

3. The method of claim 1, wherein a second 3D model of the plurality of 3D models is composed of m entities.

4. The method of claim 3, wherein the original error corresponding to an entity is based on the z distances and/or z similarities between the entity and the z nearest entities to the entity in the second 3D model based on the estimated 3D registration.

5. The method of claim 4, wherein z is 1.

6. The method of claim 1, wherein the first 3D model is a point cloud, and wherein each entity is a point.

7. The method of claim 1, wherein the first 3D model is a polygon model, and wherein each entity is a polygon.

8. The method of claim 1, wherein the set of parameters corresponding to an entity includes at least one of:
a measure of the density of entities in the vicinity of the entity in the first 3D model;
an estimation of the accuracy of the entity;
z estimations of the accuracy of the z nearest entities to the entity in the first 3D model.

9. The method of claim 3, wherein the set of parameters corresponding to an entity includes at least one of:
a measure of the density of entities in the second 3D model in the vicinity of the estimated location for the entity in the second 3D model according to the estimated 3D registration;
k_1 distances between the entity and the k_1 nearest entities to the entity in the second 3D model based on the estimated 3D registration;
k_2 similarities between the entity and the k_2 nearest entities to the entity in the second 3D model based on the estimated 3D registration;
k_3 estimations of the accuracy of the k_3 nearest entities to the entity in a second 3D model based on the estimated 3D registration.

10. The method of claim 1, wherein the set of parameters for each entity is a set of scalar parameters, and the adjusted error is a closed-form function of the scalar parameters and the original error.

11. The method of claim 10, wherein the closed-form function is a polynomial function.

12. The method of claim 1, further comprising:
applying an outliers detection criterion based on the n adjusted errors, therefore identifying a subset of the n entities as outliers.

13. The method of claim 12, further comprising:
applying an update rule on the estimated 3D registration, the plurality of 3D models, and a list of the entities identified as outliers, to obtain a new estimated 3D registration among the plurality of 3D models.

14. The method of claim 1, further comprising:
calculating a weight for each of the n entities based on the n adjusted errors, therefore obtaining a weight for each entity.

15. The method of claim 14, further comprising:
applying an update rule on the estimated 3D registration, the plurality of 3D models, and the weighted entities, to obtain a new estimated 3D registration among the plurality of 3D models.

16. The method of claim 1, further comprising:
calculating a quality measure for each of the n entities based on the n adjusted errors, therefore obtaining a quality estimation for each entity.

17. The method of claim 1, further comprising:
applying an update rule on the estimated 3D registration, the plurality of 3D models, and the n adjusted errors, to obtain a new estimated 3D registration among the plurality of 3D models.

18. A method, comprising:
obtaining a plurality of 3D models, wherein the first 3D model is composed of n entities;
obtaining an estimated 3D registration among the plurality of 3D models;
apply an update rule on the estimated 3D registration t times to obtain a new estimated 3D registration among the plurality of 3D models;
calculating an error for each of the n entities based on the estimated 3D registration, therefore obtaining n errors corresponding to the n entities;
calculating a set of parameters for each of the n entities, therefore obtaining n sets of parameters corresponding to the n entities;
obtain a threshold r;
applying an outliers detection criterion based on the n errors, the n sets of parameters, t, and the threshold r, therefore identifying a subset of the n entities as outliers.

19. The method of claim 18, wherein the plurality of 3D models is exactly two 3D models.

20. The method of claim 18, wherein a second 3D model of the plurality of 3D models is composed of m entities.

21. The method of claim 18, wherein the first 3D model is a point cloud, and wherein each entity is a point.

22. The method of claim 18, wherein the first 3D model is a polygon model, and wherein each entity is a polygon.

23. The method of claim 18, wherein the set of parameters corresponding to an entity includes at least one of:
a measure of the density of entities in the vicinity of the entity in the first 3D model;
an estimation of the accuracy of the entity;
z estimations of the accuracy of the z nearest entities to the entity in the first 3D model.

24. The method of claim 20, wherein the set of parameters corresponding to an entity includes at least one of:
a measure of the density of entities in the second 3D model in the vicinity of the estimated location for the entity in the second 3D model according to the new estimated 3D registration;
k_1 distances between the entity and the k_1 nearest entities to the entity in the second 3D model based on the new estimated 3D registration;
k_2 similarities between the entity and the k_2 nearest entities to the entity in the second 3D model based on the new estimated 3D registration;
k_3 estimations of the accuracy of the k_3 nearest entities to the entity in a second 3D model based on the new estimated 3D registration.

25. The method of claim 18, further comprising:
applying an update rule on the new estimated 3D registration, the plurality of 3D models, and a list of the entities identified as outliers, to obtain a newer estimated 3D registration among the plurality of 3D models.

26. A software product stored on a non-transitory computer readable medium and comprising data and computer implementable instructions for carrying out the method of claim 1.

27. A software product stored on a non-transitory computer readable medium and comprising data and computer implementable instructions for carrying out the method of claim 18.

28. An apparatus, comprising:
at least one 3D camera, configured to capture a plurality of 3D models, wherein the first 3D model is composed of n entities;
at least one processor, configured to:
obtaining an estimated 3D registration among the plurality of 3D models;
calculating an original error for each of the n entities based on the estimated 3D registration, therefore obtaining n original errors corresponding to the n entities;
calculating a set of parameters for each of the n entities, therefore obtaining n sets of parameters corresponding to the n entities;
calculating an adjusted error for each of the n entities based on the n original errors and the n sets of parameters, therefore obtaining n adjusted errors corresponding to the n entities;
processing information related to the n entities based on the n adjusted errors.

29. The apparatus of claim 28, wherein the plurality of 3D models is exactly two 3D models.

30. The apparatus of claim 28, wherein a second 3D model of the plurality of 3D models is composed of m entities.

31. The apparatus of claim 30, wherein the original error corresponding to an entity is based on the z distances and/or z similarities between the entity and the z nearest entities to the entity in the second 3D model based on the estimated 3D registration.

32. The apparatus of claim 31, wherein z is 1.

33. The apparatus of claim 28, wherein the first 3D model is a point cloud, and wherein each entity is a point.

34. The apparatus of claim 28, wherein the first 3D model is a polygon model, and wherein each entity is a polygon.

35. The apparatus of claim 28, wherein the set of parameters corresponding to an entity includes at least one of:
a measure of the density of entities in the vicinity of the entity in the first 3D model;
an estimation of the accuracy of the entity;
z estimations of the accuracy of the z nearest entities to the entity in the first 3D model.

36. The apparatus of claim 30, wherein the set of parameters corresponding to an entity includes at least one of:
a measure of the density of entities in the second 3D model in the vicinity of the estimated location for the entity in the second 3D model according to the estimated 3D registration;
k_1 distances between the entity and the k_1 nearest entities to the entity in the second 3D model based on the estimated 3D registration;
k_2 similarities between the entity and the k_2 nearest entities to the entity in the second 3D model based on the estimated 3D registration;
k_3 estimations of the accuracy of the k_3 nearest entities to the entity in a second 3D model based on the estimated 3D registration.

37. The apparatus of claim 28, wherein the set of parameters for each entity is a set of scalar parameters, and the adjusted error is a closed-form function of the scalar parameters and the original error.

38. The apparatus of claim 37, wherein the closed-form function is a polynomial function.

39. The apparatus of claim 28, wherein the at least one processor is further configured to:
applying an outliers detection criterion based on the n adjusted errors, therefore identifying a subset of the n entities as outliers.

40. The apparatus of claim 39, wherein the at least one processor is further configured to:
applying an update rule on the estimated 3D registration, the plurality of 3D models, and a list of the entities identified as outliers, to obtain a new estimated 3D registration among the plurality of 3D models.

41. The apparatus of claim 28, wherein the at least one processor is further configured to:
calculating a weight for each of the n entities based on the n adjusted errors, therefore obtaining a weight for each entity.

42. The apparatus of claim 41, wherein the at least one processor is further configured to:
applying an update rule on the estimated 3D registration, the plurality of 3D models, and the weighted entities, to obtain a new estimated 3D registration among the plurality of 3D models.

43. The apparatus of claim 28, wherein the at least one processor is further configured to:
calculating a quality measure for each of the n entities based on the n adjusted errors, therefore obtaining a quality estimation for each entity.

44. The apparatus of claim 28, wherein the at least one processor is further configured to:
applying an update rule on the estimated 3D registration, the plurality of 3D models, and the n adjusted errors, to obtain a new estimated 3D registration among the plurality of 3D models.

45. An apparatus, comprising:
at least one 3D camera, configured to capture a plurality of 3D models, wherein the first 3D model is composed of n entities;
at least one processor, configured to:
obtaining plurality of 3D models, wherein the first 3D model is composed of n entities;
obtaining an estimated 3D registration among the plurality of 3D models;
apply an update rule on the estimated 3D registration t times to obtain a new estimated 3D registration among the plurality of 3D models;
calculating an error for each of the n entities based on the estimated 3D registration, therefore obtaining n errors corresponding to the n entities;
calculating a set of parameters for each of the n entities, therefore obtaining n sets of parameters corresponding to the n entities;
obtain a threshold r;
applying an outliers detection criterion based on the n errors, the n sets of parameters, t, and the threshold r, therefore identifying a subset of the n entities as outliers.

46. The apparatus of claim 29, wherein the plurality of 3D models is exactly two 3D models.

47. The apparatus of claim 29, wherein a second 3D model of the plurality of 3D models is composed of m entities.

48. The apparatus of claim 29, wherein the first 3D model is a point cloud, and wherein each entity is a point.

49. The apparatus of claim 29, wherein the first 3D model is a polygon model, and wherein each entity is a polygon.

50. The apparatus of claim 29, wherein the set of parameters corresponding to an entity includes at least one of:
a measure of the density of entities in the vicinity of the entity in the first 3D model;
an estimation of the accuracy of the entity;
z estimations of the accuracy of the z nearest entities to the entity in the first 3D model.

51. The apparatus of claim 47, wherein the set of parameters corresponding to an entity includes at least one of:
a measure of the density of entities in the second 3D model in the vicinity of the estimated location for the entity in the second 3D model according to the new estimated 3D registration;
k_1 distances between the entity and the k_1 nearest entities to the entity in the second 3D model based on the new estimated 3D registration;
k_2 similarities between the entity and the k_2 nearest entities to the entity in the second 3D model based on the new estimated 3D registration;
k_3 estimations of the accuracy of the k_3 nearest entities to the entity in a second 3D model based on the new estimated 3D registration.

52. The apparatus of claim 29, wherein the at least one processor is further configure to:
applying an update rule on the new estimated 3D registration, the plurality of 3D models, and a list of the entities identified as outliers, to obtain a newer estimated 3D registration among the plurality of 3D models.
